(19) United States
(12) Patent Application Publication
(10) Pub. No.: US 2012/0109720 A1
(43) Pub. Date: May 3, 2012

(54) Intelligent location system

(76) Inventors: Brandon James Kibby, Melbourne (AU); Robert Kovacic, Highton (AU)

(21) Appl. No.: 12/925,706

(22) Filed: Oct. 27, 2010

(51) Int. Cl. G06Q 10/00; G01C 21/00

(52) U.S. Cl. 705/7.38; 701/465; 701/537

(57) ABSTRACT

An intelligent location system for automatically determining and recording a recordable event by automatically determining a combination of the following criteria:
a. position analysis of the user;
b. correlation of position analysis of the user with one of the one or more predetermined defined client or facility locations;
c. time analysis of position of the user at the one of the one or more of the predetermined defined client or facility locations; and
   wherein only when all the above three criteria are correlated does a recordable event occur and is recorded.

### PRIORITY

This application claims priority from PCT patent application PCT/AU2008/000102, filed Jan. 31, 2008.

### FIELD OF INVENTION

This invention relates to an intelligent location system. In particular it relates to an intelligent location system for use in assessing effectiveness of commercial trade but is not limited to such.

Salesmen and service providers spend a substantial period of time on the road providing sales and service to clients and various locations. It is further necessary to make such activities efficient and also to associate a cost with each client.

In the prior art it is known to have the delivery vehicle fleet tracking. However this is more a system for guiding the fleet to the destination and including intelligent scheduling. This could be considered to be the reverse of the present system and therefore not relevant.

It is also known to make use of Personal Digital Assistants (PDIs) such as Palm Pilots™ or the like by delivery couriers or service providers. However this does not usually include time duration input and is dependent on the input by the provider, which can result in errors or omissions and not full data analysis.

Many devices make use of global positioning system using triangulation with various orbiting satellites, and therefore are readily viable to obtain a particular location. Such location is quite useful in providing feedback of positioning to the user so they can determine where they are. It is known to use that determined position and by a selection of a destination point on a map have a route automatically determined on the map. Further it is noted though that there are some problems associated with putting this broad concept into practice including Global Positioning System (GPS) drop out and unusual results. Further it does not allow for variations due to traffic delays, time outs for lunch or rest stops.

Another problem in providing a method for gathering commercially relevant location-based data is the need to maintain privacy of the salesmen or service provider. It is therefore not acceptable to have continuous monitoring system of a location of a person at all times regardless of activity.

Therefore there is a need to provide an intelligent location system that overcomes or at least ameliorates the problems of the prior art.

### SUMMARY OF THE INVENTION

In accordance with the invention there is provided an intelligent location system for automatically determining and recording a recordable event by automatically determining a combination of the following criteria:
a. position analysis of the user;
b. correlation of position analysis of the user with one of the one or more predetermined defined client or facility locations;
c. time analysis of position of the user at the one of the one or more of the predetermined defined client or facility locations; and
   wherein only when all the above three criteria are correlated does a recordable event occur and is recorded.

There can be provided one or more means, with at least one of said means being portable and carried by the user, for automatically determining one or more of the criteria. The one or more means provides an automatic output of the recordable events.

The position analysis of the user can be mapped and the predetermined client or facility location is mapped and correlated if an overlap of the mapped positions occurs. More particularly the position analysis of the user or the defined client or facility locations have a defined aura of a predefined size which is mapped and correlated if an overlap of the positions or aura of the position analysis of the user or the defined client or facility locations occur.

The time analysis can include determination and correlation of the three criteria for a predefined minimum period for a recordable event to occur. However preferably the position analysis of the user is undertaken automatically at consistent sampling times wherein the sampling time is at least less than 50% of the predefined minimum period for a recordable event to occur. Particular position analysis of the system can use global position satellites (GPS).

The system of the invention can be used in three major areas.

The first is in the area of travelling sales consultants where the person travels to the client for the sales service or after sales service or customer relation service.

The second is in the area of providing services to people at various locations. This can include nurses, doctors, lawyers or other professional services requiring contact with people at their homes or business locations.

The third is in the area of providing services on facilities and various locations. This can include gas meter readers, and building or health inspectors, painters or other service providers contracted to provide a service on or about a facility at the located position of that facility.

it can be seen that the invention of provides a system that crisis that allows for accurate record all of only relevant events for use in determining the effectiveness of the user that needs to undertake travel. In particular it does not keep records of non relevant periods such as not work time periods or periods not involved in the client or facility interaction. It still further allows systems and apparatus to be cost-effective and battery conscious by only requiring sampling at predetermine intervals, rather than continuous monitoring.

Overall the system and a bronze of the invention overcomes a multitude of the problems of the prior art including the problem of it at “Big Brother” watching antique filters out any non local incidental activities and concentrates surely on relevant interactions that form a defined recordable event.

Therefore the invention in one form provides a method having the steps of:
a) defining a geocode for a list of customers;
b) collecting GPS data of movements of travelling representative;
c) undertaking review of position when within fixed radius over a fixed time limit (i.e. with 50 metres for greater than 15 minutes)
d) undertaking matching of reviewed position with listed geocodes;
e) correcting anomalies;
f) obtaining commercial indicator of customer such as sales at particular visit, sales per month; and
g) undertaking effectiveness study of time expended per customer indicator.

It can therefore be seen that the system allows accurately measuring of face-to-face contact between travelling client relations representatives including sales representatives, merchandisers, service providers or consultants and each customer. It therefore allows you to accurately assess the cost returned on all direct contact of such people in your business. Therefore the system allows a more strategic and measurable approach to correct customer contact. Further it helps facilitate a complete short medium or long-term strategy framework.

The system allows benefits in two major areas. The first includes the management of customers. It allows optimal visits, meetings obligations to make customer contact, in assessing the cost and benefit, and a comparison of effectiveness between different sales representatives, merchandisers, service providers or consultants.

The other major area is management of the sales team. The system allows management to plan the overall use of the sales team, to verify the actual use of the sales team, determine the time spent by the sales team and the relevant outcomes and divide a comparison of the effectiveness of the sales team between each other or as a team over different locations different time periods or for different activities.

Software is provided that can run on a “GPS smartphone” and periodically gathers location data. It runs unobtrusively in the background and requires no interaction with the user.

One of the major considerations is power conservation, so the program turns itself off at the end of a working day, restarts itself at the start of the next working day (and does not run on weekends). Further on power conservation, if the program simply “switched on” the GPS for the whole day, the battery would be depleted well before the end of the day. Therefore the software only switches the GPS on every few minutes, allows a short time (up to 13 minutes for the first GPS reading of the day, and approx. 3 minutes thereafter) to acquire a reading and then switches it off again.

Another problem to be overcome is that any coordinates that cannot be confirmed as having a preset accuracy (horizontal dilution of precision (HDOP)<9) are ignored.

The GPS coordinates are stored in the phone till the end of the day when they are transferred (together with identification data) to a central server. This transfer happens automatically, with various retry and fallback procedures, using the internet access facilities of the phone. Minimizing the amount of stored data and transferring the data once at the end of the day, ensures minimum power consumption and minimum carrier costs charged to the user.

Software runs at the Client's premises gathering and analysing data. The data storage and analysis software can run on a “standard” personal computer using a Windows operating system that has an internet connection and allows the client to programmably import and update customers' name and address details into the database. Initially the software geocodes of the customer file for the client are required.

The software contacts the server and downloads any new files that have been uploaded for the mobile phones and then removes them from the server. Since there could be very many (tens of thousands or more) customers to individually match for each phone data coordinate, the software first narrows down the possible customers to those within a geo-coordinate search rectangle that encompasses the current set of phone data. If the coordinates in the downloaded file are within a user specified distance from a customer on file, then that data is used and stored, otherwise the data is discarded.

While processing the downloaded phone data, the software accumulates the time between the first recorded coordinate within a customer's proximity and the first recorded coordinate outside the proximity as the “visit duration”.
The Phone ID, Rep Name, Date, Customer and Duration are stored as individual Visit records.
Each Customer record is also updated with a summary of the Last Visit Date and Duration, and a Number of Visits and Duration for each of the preceding 12 months

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

In order that the invention can be more readily understood an embodiment will be described by way of illustration only with reference to the drawings wherein:

FIG. 1 shows an illustrative example of the use certain embodiments of an intelligent location system of the invention;

FIGS. 2 and 3 show alternative illustrative diagram of the interaction of components of the intelligent location system according to certain embodiments of the invention;

FIG. 4 shows an example of formation of a computer screen output of information relating to a customer and correlation between sales and visits identified by the intelligent location system of invention;

FIGS. 5 and 6 shows the versatility of the output of information of FIG. 4 according to certain embodiments of the invention;

FIG. 7 shows an output list customer summary report making use of the determination of the output by FIGS. 3 to 6;

FIGS. 8, 9 and 10 is an example of formation of a computer screen output of information relating to a customer visit and correlation between the visitor with the and visits identified by the intelligent location system of invention;

FIG. 11 shows an output list customer summary report making use of the determination of the output by FIGS. 8 to 10;

FIG. 12 is an example of formation of a computer screen output of information relating to a customer management of the and correlation between the visitor with the and visits identified by the intelligent location system of invention;

FIG. 13 shows an output lid customer summary report making use of the determination of the output by FIGS. 8 to 10;

FIG. 13 shows an illustrative use of a list of relevant recorded visits of concern; and

FIG. 14 shows an illustrative use of a list of relevant recorded visits of a particular client in each month.

### DETAILED DESCRIPTION OF THE PREFERRED EMBODIMENT

Preferred embodiments of the present invention provide a system and a methodology for intelligent location system of invention to enable a commercial effectiveness review. The data is gathered in a non-intrusive manner to fully explore and cover the customer region. In particular the position of the user is not maintained at all times. Instead it is only the correlation of the position of the user to the location of the client that is maintained. This correlation is time analysed so that the effectiveness can be assessed.

The intelligent location system provides advantages from automatically gathering location information about user position but only providing information in a recordable event when that user position is relevant by its correlation with the position of the client. Therefore the privacy of the user, such as a salesman, is maintained while the business use of a salesman is able to be effectively monitored. This distinction between the two has never been possible by previous methods.

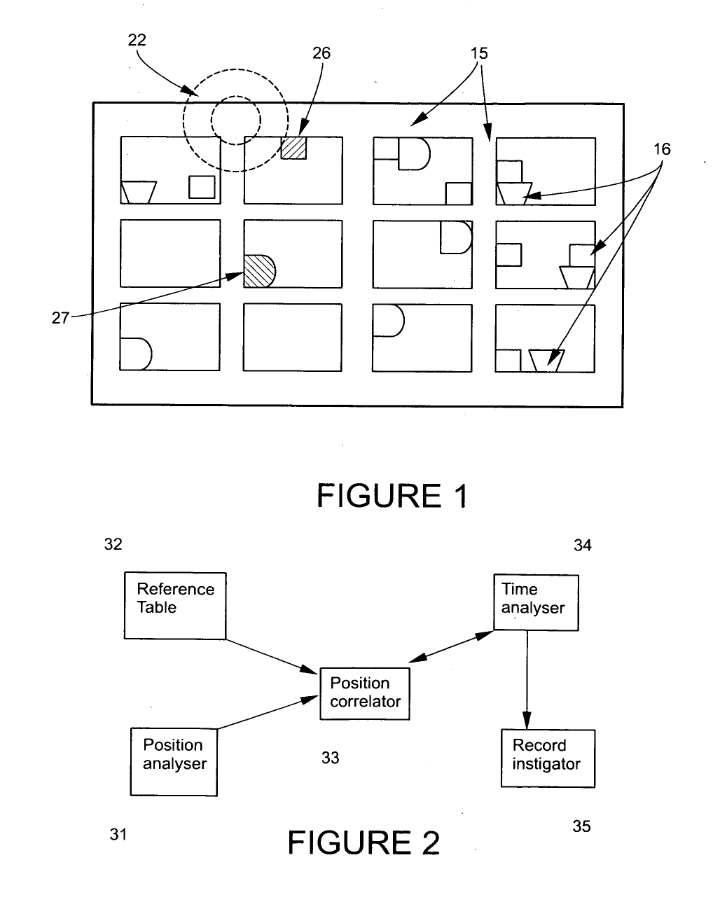

Referring to FIGS. 1, 2 and 3 there is shown an illustrative examples of the use in certain embodiments of an intelligent location system of the invention. In particular in FIG. 1 there is shown a network of streets that intersect and a plurality of buildings within that network. Definition of a particular business can be identified as 26 and 27.

The intelligent location system of the invention assists the sales representatives on the road and determining their effectiveness by an automatic tracking system. At predetermined intervals such as every five minutes a position analysis of the travelling client relations representatives is automatically undertaken by a portable means having global positioning satellite (GPS) equipment. However the equipment may have its own automatic assessment interval.

As shown in FIG. 2, such information is not used until a second step of correlation of the position analysis with predetermined client location at 26 and 27 is within the general area of the sales representatives or within the defined aura 22 of the user.

The GPS position may be accurate to varying degrees in varying densities such as within 20 metres in open area. However in a close city environment there could be a number of dead spots and therefore the last recorded position may be some 50 to 100 metres away. Therefore in the correlation a predetermined radius of the position may be instigated depending on the general density of the general position of the user.

By this correlation the user can be identified as being at the location of a first customer at position 26. Therefore a time period may be allocated, such as minimum of five minutes, to undertake another assessment of whether a business interaction is occurring between the user and the client at position 26. An alternative situation could be that the salesman is merely passing the location 26 on the way to location 27.

At the next time period review such as five minutes later, if the user is still located generally at position 26 the system will determine that the user is undertaking a business interaction with the client at position 26 and a record will be instigated to show that business interaction. At a still further next time period such as five minutes later hour, if sampling in five-minute periods, the analysis will be undertaken again until the user is shown to have left the relative location of the client at position 26. The instigated record can then conclude its time period and for example allocate a 30 minute period to the business interaction of the user with the client at position 26.

In the alternative is that at the later period the user was not located generally at position 26, the system will not instigate a record and therefore the user's position will not be recorded.

However, if at the following next time periods, the user is determined to be at position 27 for a period longer than the predetermined period such as five minutes, a record will be instigated to show a business interaction of the user with the second client at position 27. The position reviews can be used to show the expense of this business interaction in each instigated record of, for example, a time period of 20 minutes as a business interaction of the user with the client at position 27.

The componentry of the intelligent location system includes a portable means for carrying by the user, for automatically sampling, determining and recording. Generally the intelligent location system includes a position analysing device such as a GPS locating device that may be incorporated in a watch or mobile phone or other really handheld device by the user or salesman. A database is maintained of a reference table of the latitude and longitude or geocodes of a client or business database. A correlation means is provided that receives information from the position analysis device of the position of the user and derives relative location of the client locations within the general proximity.

The intelligent location system includes positioning correlation software that resides on a computing device one or more of the following criteria
a. position analysis of the user;
b. correlation of position analysis of the user with one of the one or more predetermined defined client or facility locations;
c. time analysis of position of the user at the one of the one or more of the predetermined defined client or facility locations; and
   wherein only when all the above three criteria are correlated does a recordable event occur.

Throughout a particular coverage area the client software compares the observed with those in its reference database. The data of the reference table 32 must be undertaken by gathering location data of the client to build a customer database geocode reference table. This can be undertaken as a separate project by a user when undertaking a visit to a client initiating a signal on the location device such as a GPS device in order to define the client geocode for later use. Alternatively the gathering of the data can be electronically obtained by matching and address of the client with and electronic grid of geocodes.

Therefore the reference table 32 can have a large number of client locations that can automatically be reviewed and correlated with the user's location without the user needing to undertake substantial paperwork and timekeeping practices. The location devices track the location of the user every predetermined period using signal from GPS satellites. The location device can also include the reference table and undertake the correlation of user position to 30 client location determined from the reference table.

Another approach is use of a selection of algorithms that include every single street in the target area so as to avoid dead spots in the resulting collection of data thus producing a more reliable positioning system for the end users.

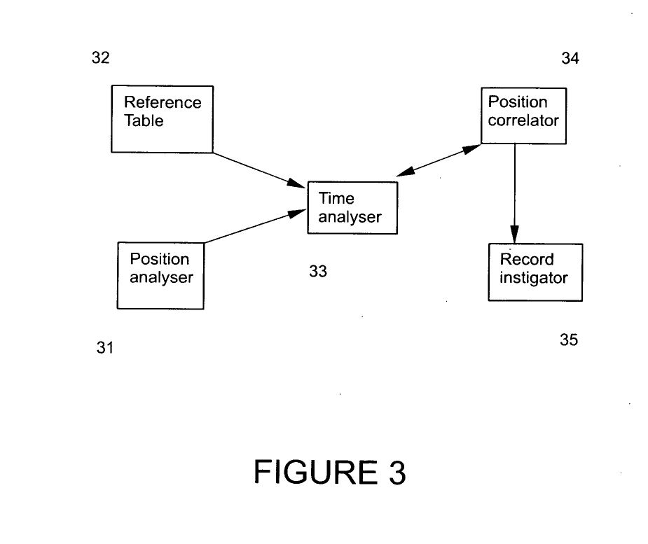

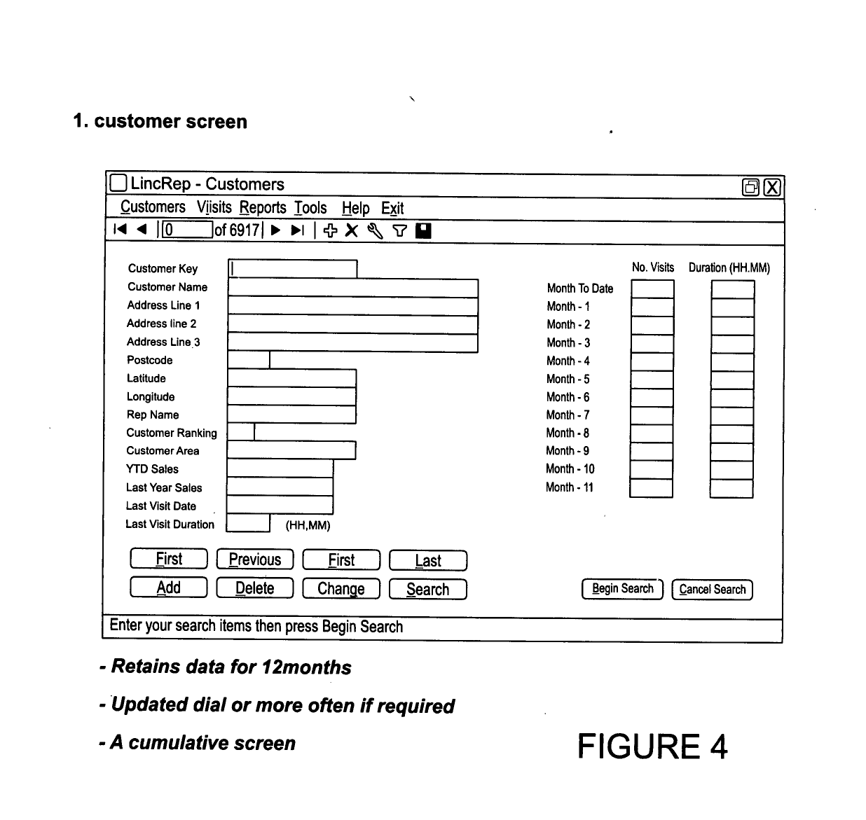

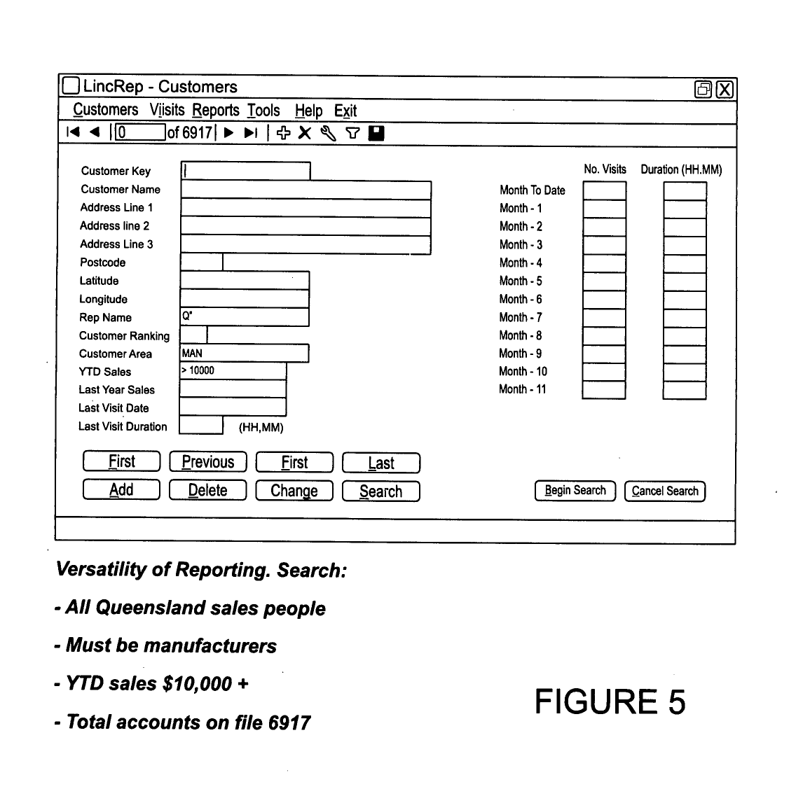

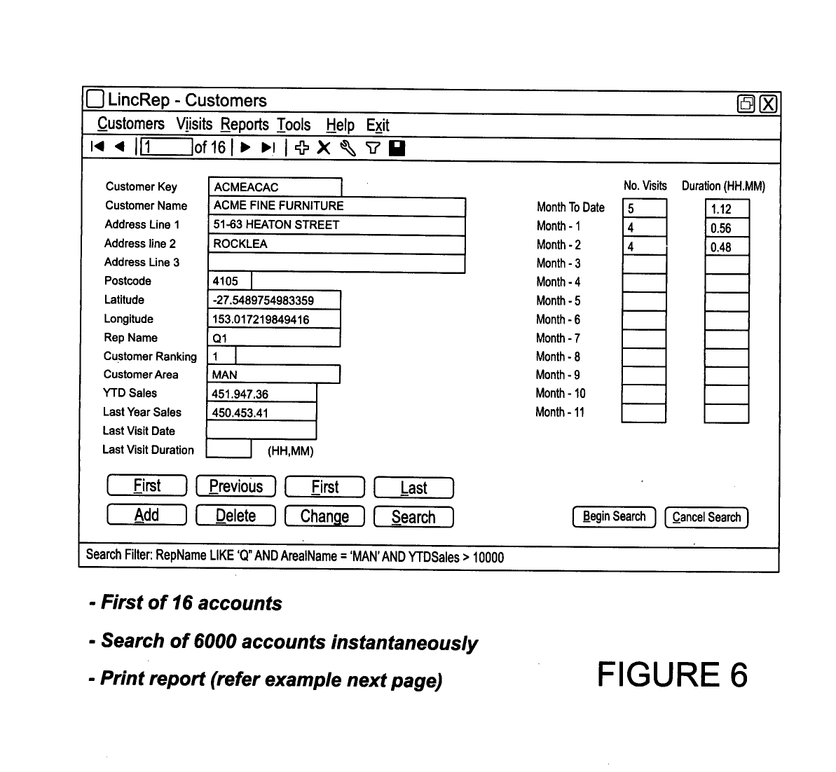

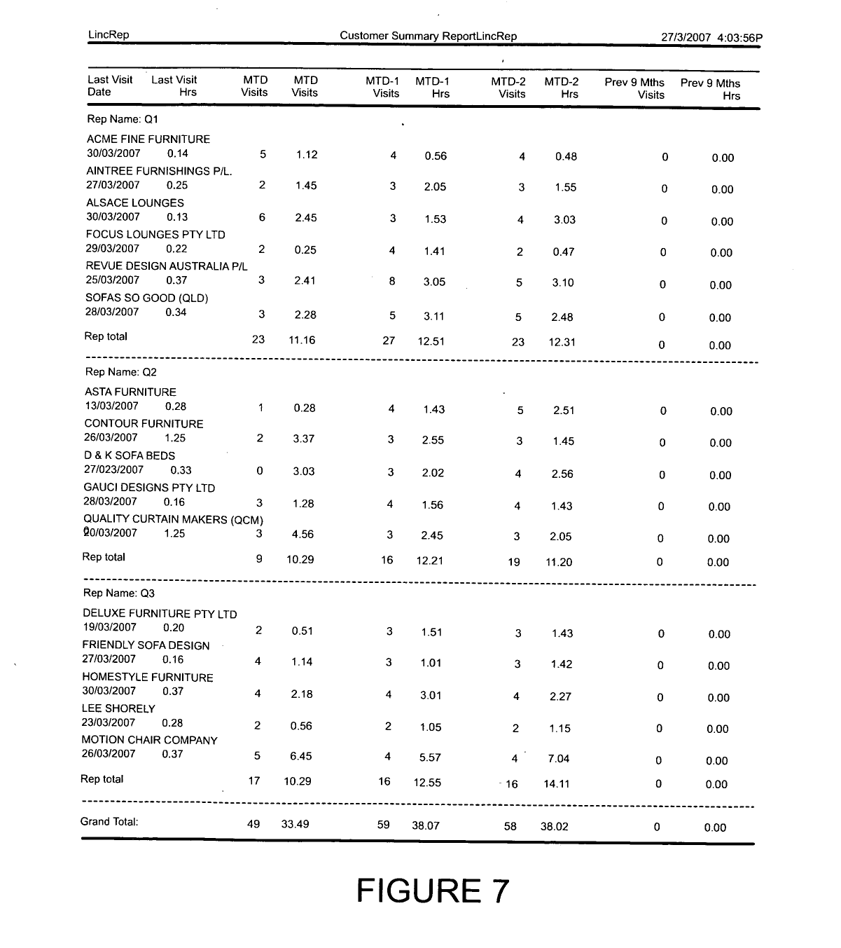

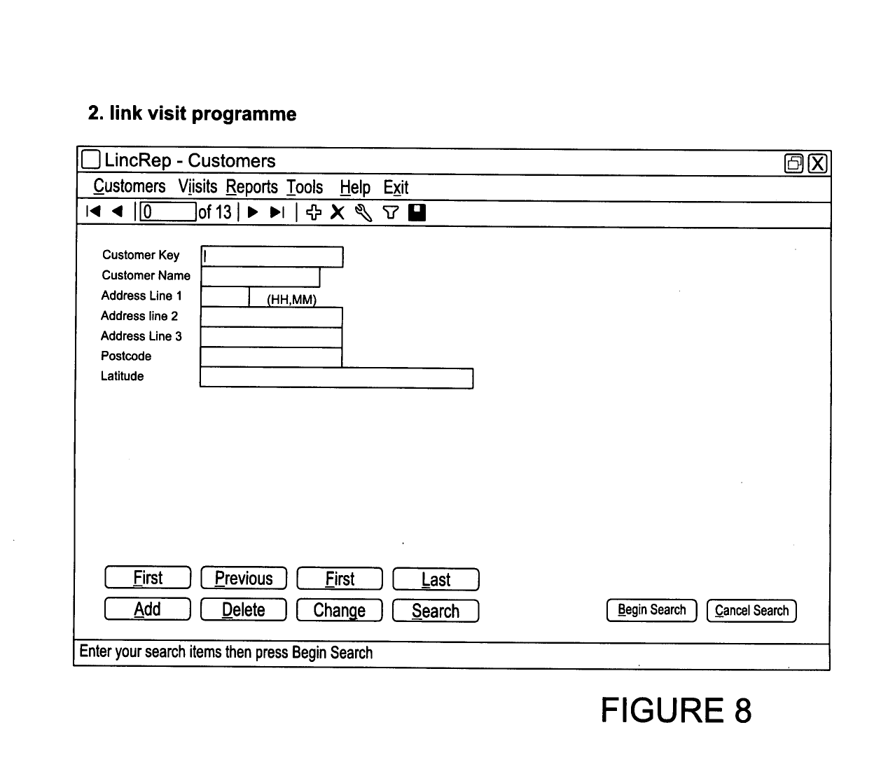

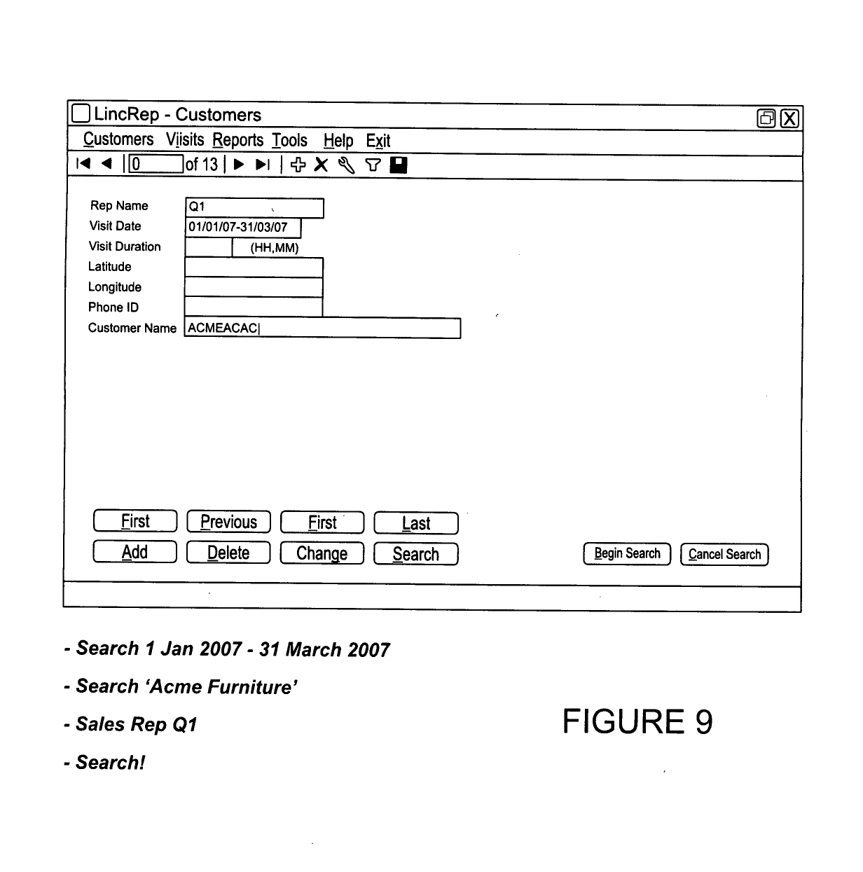

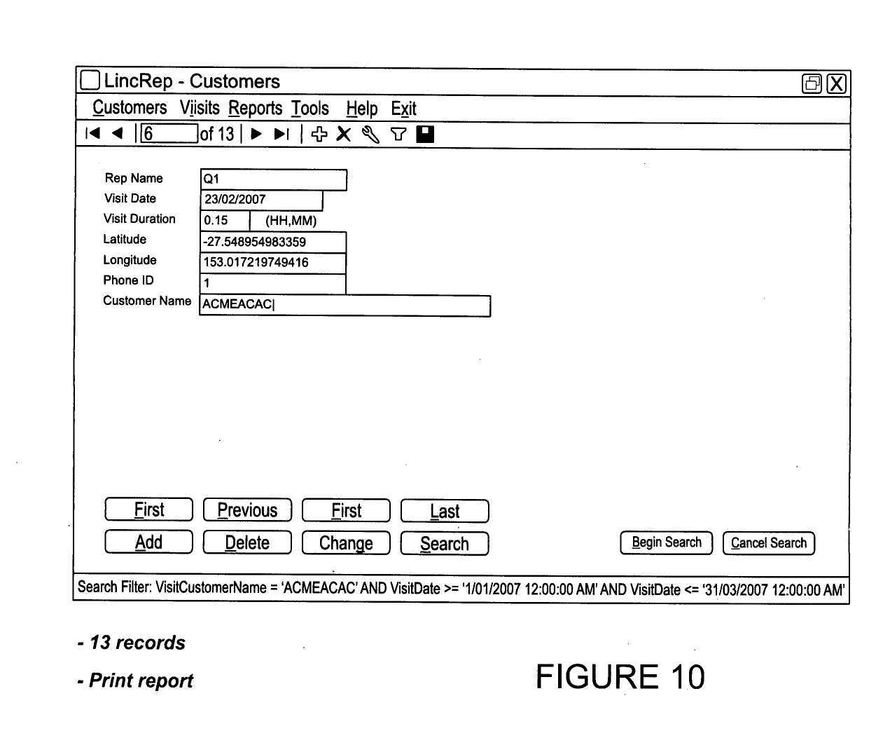

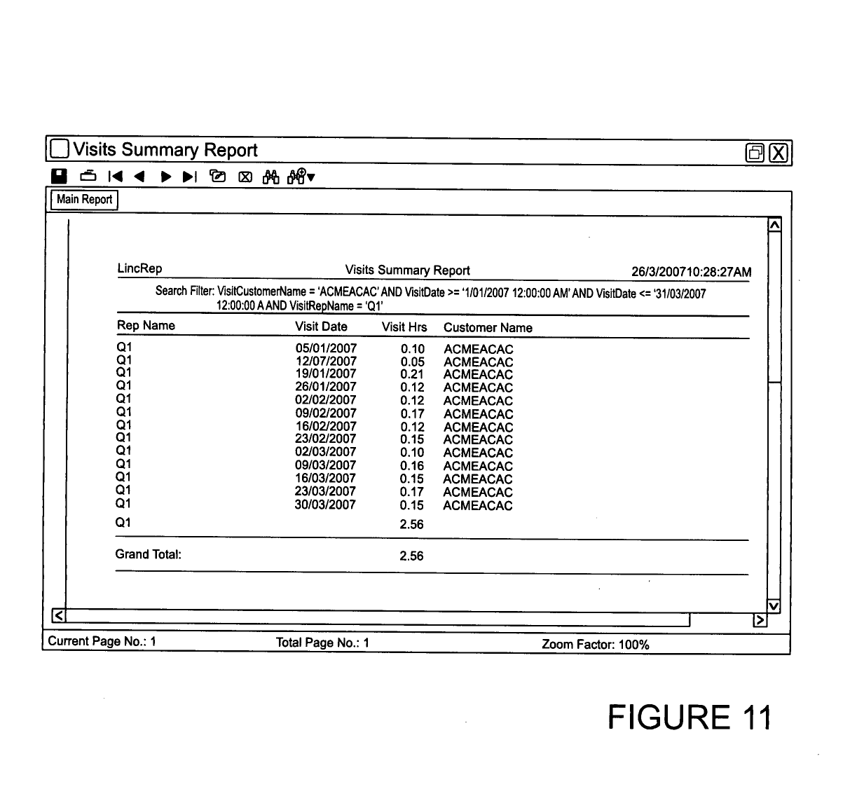

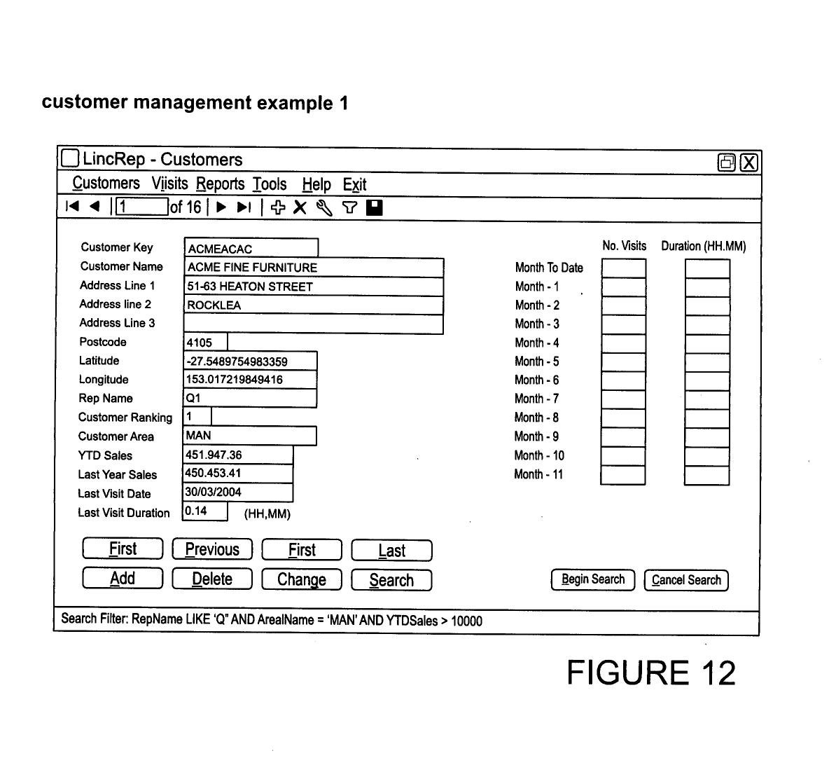

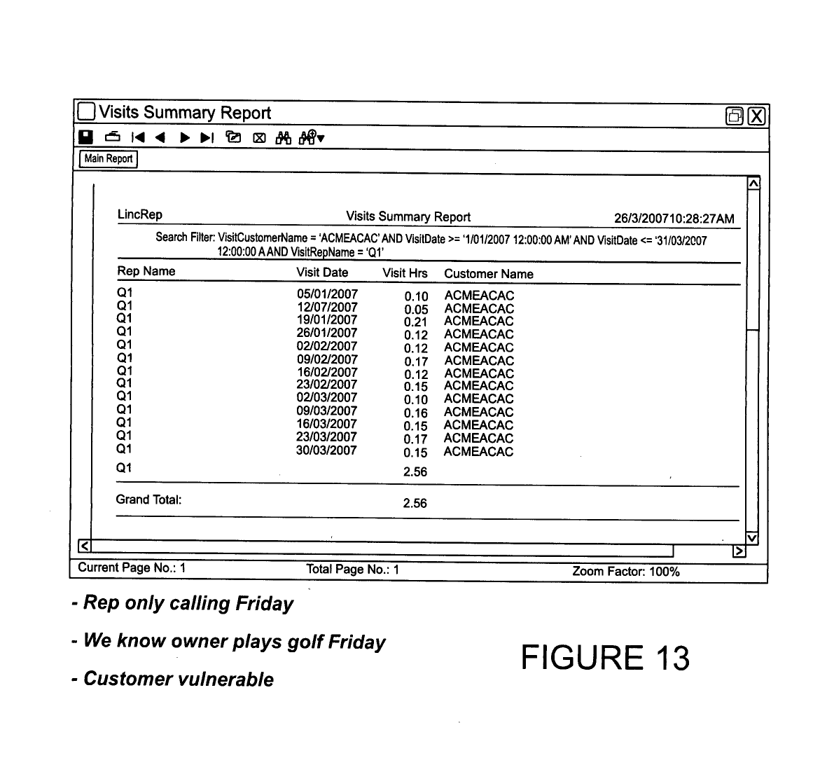

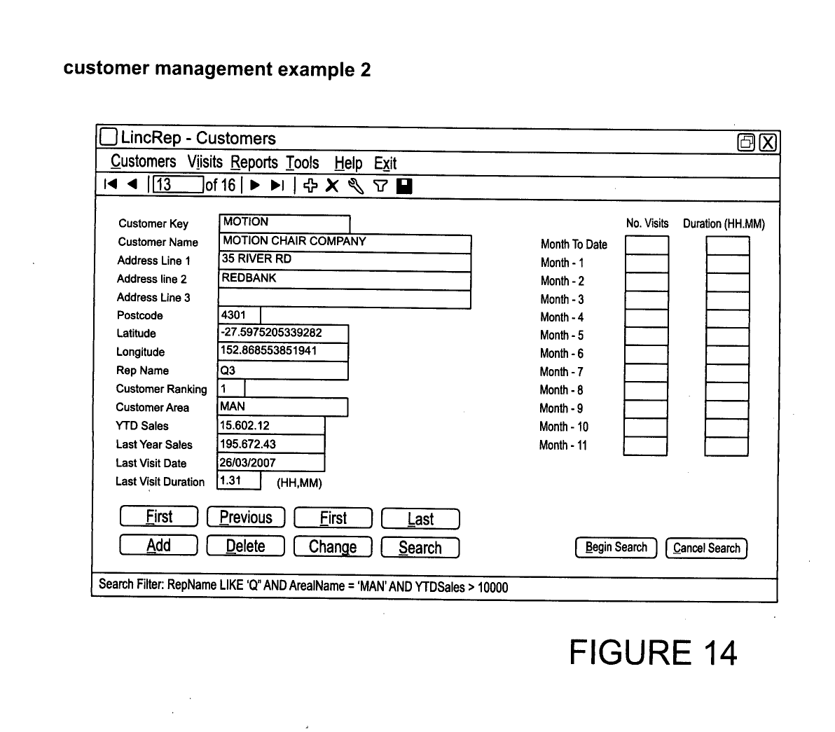

As shown in FIG. 3, instead of the portable means carried by the user undertaking all of the correlation, a remote server may interact with the portable means either wirelessly or by connection at defined times in a day or when returning to the user's workplace.

In this format the reference table can be on the server and the position analyser and time analyser information can be inputted to the server where a position correlation is undertaken to determine the recordable events.

Once collected (or partially collected), the correlated position data is uploaded back to a central access point database (described later in this application) where it is processed. The location points for each record of interval are used to reverse triangulate the actual physical location of the user. In order to produce the most accurate correlated location for a particular user and a particular client location or to create the most accurate user effectiveness profile, the correlated position must observe the general access position from as many different possibilities. To undertake this difficult task a general range of position of the user is predetermined sussed the move on to office to office within a client's premises or exit by a different door to the entrance is clearly correlated with the business interaction of the user with the client.

The time analysis correlation further eliminates incidental or incorrect correlation of the user position to the client location in order to provide a high degree of accuracy of actual relevant user interactions having business relations with clients or attending to facilities at the defined positions.

The system allows management of customers by allowing optimal visits, meetings obligations to make customer contact, in assessing the cost and benefit, and a comparison of effectiveness between different sales representatives, merchandisers, service providers or consultants, the method including the steps of:
a. Undertaking an assessment of time analysis of the customer position by the correlated position of the time analysis of the travelling client relations representatives with the predetermined client location;
b. Providing a time period review of a multiple visits in a defined period;
c. Undertaking correlation of sales or service provided to the customer with the assessed time analysis; and
d. Undertaking comparative analysis.

The method of management of a sales team, to verify the actual use of the sales team, determines the time spent by the sales team and the relevant outcomes and divide a comparison of the effectiveness of the sales team between each other or as a team over different locations different time periods or for different activities the method including the steps of:
a. Undertaking an assessment of time analysis of the customer position by the correlated position of the time analysis of the travelling client relations representatives with the predetermined client location;
b. Providing a time period review of a plurality of users' visits in a defined period;
c. Undertaking correlation of sales or service provided by the plurality of users; and
d. Undertaking comparative analysis.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. An intelligent location system for automatically determining and recording a recordable event by automatically determining a combination of the following criteria:
a. position analysis of the user;
b. correlation of position analysis of the user with one of the one or more predetermined defined client or facility locations;
c. time analysis of position of the user at the one of the one or more of the predetermined defined client or facility locations; and
wherein only when all the above three criteria are correlated does a recordable event occur and is recorded.

2. The intelligent location system according to claim 1 including providing one or more means, with at least one of said means being portable and carried by the user, for automatically determining one or more of the criteria.

3. The intelligent location system according to claim 2 wherein one of the one or more means provides an automatic output of the recordable events.

4. The intelligent location system according to claim 3 wherein the position analysis of the user is mapped and the predetermined client or facility location is mapped and automatically correlated to determine when an overlap of the mapped positions occurs and determine when the user is at the substantially same position for more than the predefined period.

5. The intelligent location system according claim 4 wherein at least one of the position analysis of the user or the defined client or facility locations have a defined aura of a predefined size according to the density and other criteria of the defined client or facility locations and which is mapped and correlated to determine if an overlap of the positions or aura of the position analysis of the user with the defined client or facility locations occur wherein the review of position includes when within fixed radius over a fixed time limit such as within 50 metres for greater than 15 minutes.

6. The intelligent location system according to claim 5 wherein the time analysis includes determination and correlation of the three criteria for a predefined minimum period for a recordable event to occur and be recorded.

7. The intelligent location system according to any one of claim 5 wherein the position analysis of the user is undertaken automatically at consistent sampling times to provide the time analysis at the substantially same position wherein the sampling time is at least less than 50% of the predefined minimum period for a recordable event to occur

8. The intelligent location system according to claim 7 including determination of client relations effectiveness by analysis of time records of time analysis of the correlated position.

9. The intelligent location system according to claim 8 including particular position analysis of the system using global position satellites (GPS).

10. A method for assisting travelling service providers including sales representatives on the road and determining their effectiveness by an automatic tracking system having the steps of:
i. defining a geocode for a list of customers or defined clients or facility locations;
ii. collecting GPS data of movements of the travelling service providers;
iii. undertaking review and matching of position with listed geocodes when within fixed radius over a fixed time limit
iv. following rules for correcting anomalies such as signal loss over limited period;
v. obtaining commercial indicator of customer or defined clients or facility locations such as sales at particular visit, sales per month, time per service; and
vi. undertaking effectiveness study of time expended per customer indicator.

11. The method according to claim 10 wherein the review of position includes when within fixed radius over a fixed time limit such as within 50 metres for greater than 15 minutes.

12. The method according to claim 11 wherein the review of position includes at least one of the position analysis of the travelling service providers or the defined client or facility locations having a defined aura of a predefined size which is mapped and correlated if an overlap of the positions or aura of the position analysis of the user or the defined client or facility locations occur.

13. A method of management of a sales team, to verify the actual use of the sales team, determine the time spent by the sales team and the relevant outcomes and divide a comparison of the effectiveness of the sales team between each other or as a team over different locations different time periods or for different activities the method including the steps of:
i. Undertaking an assessment of time analysis of the customer position by the correlated position of the time analysis of the travelling client relations representatives with the predetermined client location;
ii. Providing a time period review of a plurality of users' visits in a defined period;
iii. Undertaking correlation of sales or service provided by the plurality of users; and
iv. Undertaking comparative analysis.

14. A method of intelligent locating of a travelling client relations representatives having a location tracking means, comprising:
i. providing a reference database of calculated locations of determinable geocodes of client locations in a target area;
ii. in response to a time request determining a location of a user location by a location tracking means,
iii. receiving the determined location of the user;
iv. accessing the reference database to obtain the locations of determinable geocodes of client locations in a target area around the determined location of the user;
v. matching locations of the determined location of the user with the determinable geocodes of client locations in a target area if within a predetermined radius,
vi. if no match choosing a corresponding location-determination algorithm from a plurality of location-determination algorithms, said chosen algorithm being suited for the number of predetermined events;
vii. maintaining records of time analysis with user and determined client location, if user is located corresponding with the determined location for a predetermined minimum period.

15. The method of claim 15 wherein the calculated locations of the user are filtered to determine if the user has moved over predetermined sampling times to see if reached minimum time at a position to initiate position correlation with client geocodes included in the reference database.

16. The method of claim 15 wherein the reference database is located locally relative to the user.

17. The method of claim 16 wherein the reference database is located remotely relative to the user.

18. The method of claim 17 wherein the location of the user device is provided with latitude and longitude coordinates.

19. The method of claim 17 wherein the plurality of location-determination algorithms includes an analysis of likely customer locations and a determination method including the steps of: determining at least one of the position analysis of the user or the defined client or facility locations to have a defined aura of a predefined size which is mapped and correlated if an overlap of the positions or aura of the position analysis of the user or the defined client or facility locations occur.

20. The method of claim 20 wherein the plurality of location-determination algorithms includes a nearest client review.
